(19) United States
(12) Patent Application Publication
(10) Pub. No.: US 2026/0111951 A1
(43) Pub. Date: Apr. 23, 2026

(54) INFORMATION PROCESSING SYSTEM, MANAGEMENT APPARATUS, AND DEVICE MANAGEMENT METHOD

(71) Applicants: Yuuki OGAWA, Tokyo (JP); Ryuichiro NAKAYAMA, Kanagawa (JP); Keisuke MORI, Yamanashi (JP)

(72) Inventors: Yuuki OGAWA, Tokyo (JP); Ryuichiro NAKAYAMA, Kanagawa (JP); Keisuke MORI, Yamanashi (JP)

(21) Appl. No.: 19/363,672

(22) Filed: Oct. 21, 2025

(30) Foreign Application Priority Data
Oct. 22, 2024 (JP) 2024-186127

(51) Int. Cl. G06Q 30/0645; G06Q 10/087

(52) U.S. Cl. CPC G06Q 30/0645; G06Q 10/0877

(57) ABSTRACT

An information processing system includes a memory and circuitry. The memory stores first information indicating a usage state of each of a plurality of devices in a storage facility based on information transmitted from the storage facility. The circuitry selects a device that is rentable from among the plurality of devices stored in the storage facility based on the first information stored in the memory. The circuitry transmits a selection result to the storage facility.

### CROSS-REFERENCE TO RELATED APPLICATIONS

This patent application is based on and claims priority pursuant to 35 U.S. C. § 119(a) to Japanese Patent Application No. 2024-186127, filed on Oct. 22, 2024, in the Japan Patent Office, the entire disclosure of which is hereby incorporated by reference herein.

### BACKGROUND

### Technical Field

The present disclosure relates to an information processing system, a management apparatus, and a device management method.

### Related Art

Recently, devices are used in all situations and are also used in many work sites. Although the operation of the device differs depending on the type of work or the content of work, there are many cases where a sufficient number of devices used only under specific circumstances are prepared with respect to the number of simultaneous uses of users (workers) and shared and used among a plurality of users. As a means for this, a physical locker (as follows, may be simply referred to as a “smart locker”) having a user authentication function is used. A product having a function of safely storing a device and renting and returning the device has already been proposed. In addition, a product has already been proposed that has a function of monitoring the state of a device and a function of preventing the renting of a device in a defective state such as a software/hardware failure, low battery, or insufficient charge in response to a rental request from a user to the smart locker.

As a system for managing such devices, a system for managing the renting and returning of devices such as shared notebook computers has been proposed.

### SUMMARY

The present disclosure described herein provides an information processing system. The information processing system includes a memory and circuitry. The memory stores first information indicating a usage state of each of a plurality of devices in a storage facility based on information transmitted from the storage facility. The circuitry selects a device that is rentable from among the plurality of devices stored in the storage facility based on the first information stored in the memory. The circuitry transmits a selection result to the storage facility.

The present disclosure described herein provides a management apparatus including circuitry. The circuitry stores, in a memory, first information indicating a usage state of each of a plurality of devices in a storage facility based on information transmitted from the storage facility which stores a plurality of devices. The circuitry selects a device that is rentable from among the plurality of devices stored in the storage facility based on the first information stored in the memory. The circuitry transmits a selection result to the storage facility.

The present disclosure described herein provides a device management method. The device management method includes storing, in a memory, first information indicating a usage state of each of a plurality of devices in a storage facility based on information transmitted from the storage facility which stores a plurality of devices. The device management method includes selecting a device that is rentable from among the plurality of devices stored in the storage facility based on the first information stored in the memory. The device management method includes transmitting a selection result to the storage facility.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic view of an information processing system;

FIG. 2 is a diagram illustrating an outline of an operation of an information processing system;

FIG. 3 is a diagram illustrating a work time during which a user uses an information technology (IT) device;

FIG. 4 is a diagram illustrating a usage time of an IT device by a user in one month;

FIG. 5 is a diagram illustrating a hardware configuration of, e.g., a locker device management system;

FIG. 6 is a diagram illustrating a hardware configuration of an IT device;

FIG. 7 is a diagram illustrating a functional configuration of an information processing system;

FIG. 8 is a diagram illustrating device usage information;

FIG. 9 is a diagram illustrating battery discharge rate information;

FIG. 10 is a diagram illustrating error occurrence history information;

FIG. 11 is a diagram illustrating device installation information;

FIG. 12 is a diagram illustrating screen transition for priority setting in an information processing system;

FIG. 13 is a sequence diagram illustrating a flow of a data collection operation of an information processing system;

FIG. 14 is a sequence diagram illustrating a flow of a device renting operation of an information processing system; and

FIG. 15 is a diagram illustrating screen transition in a locker system in a device renting operation of an information processing system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system, a management apparatus, a device management method, and a non-transitory recording medium storing a program according to embodiments of the present disclosure are described below with reference to the accompanying drawings. The present disclosure, however, is not limited to the following embodiments, and constituent elements of the following embodiments include elements conceivable by those skilled in the art, substantially the same elements, and elements within so-called equivalent ranges. Furthermore, various omissions, substitutions, changes, and combinations of the constituent elements may be made without departing from the gist of the following embodiments.

### Schematic View and Outline of Operation of Information Processing System

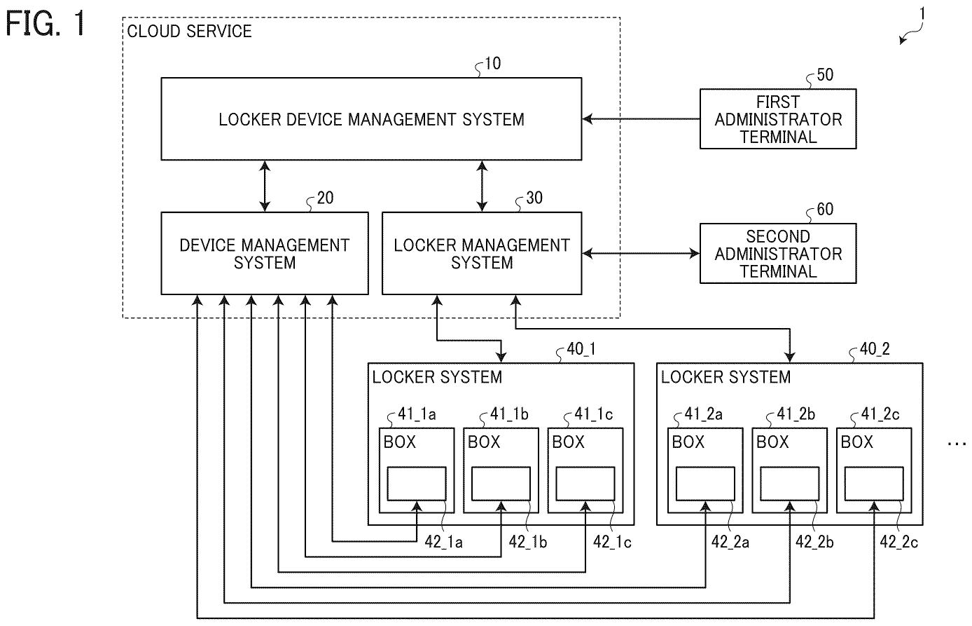

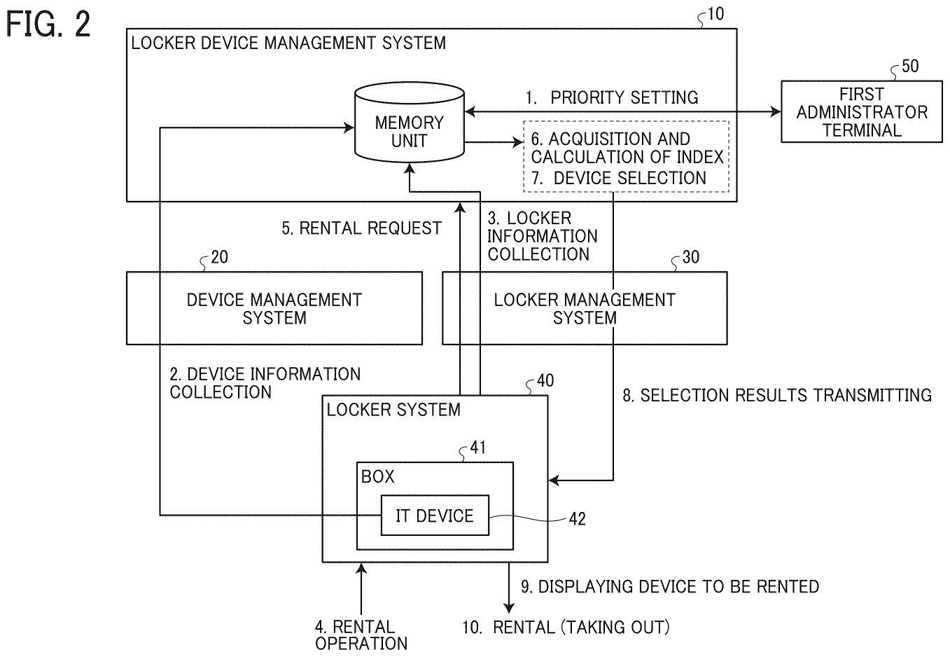

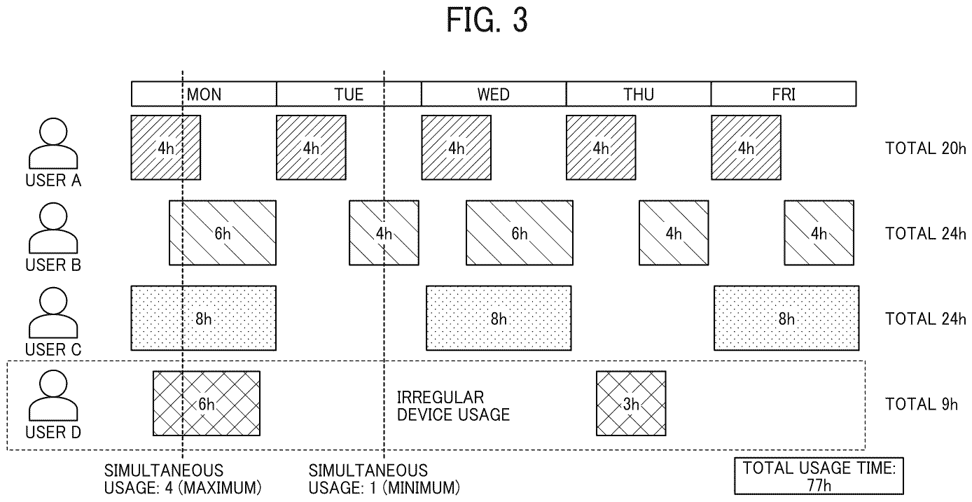

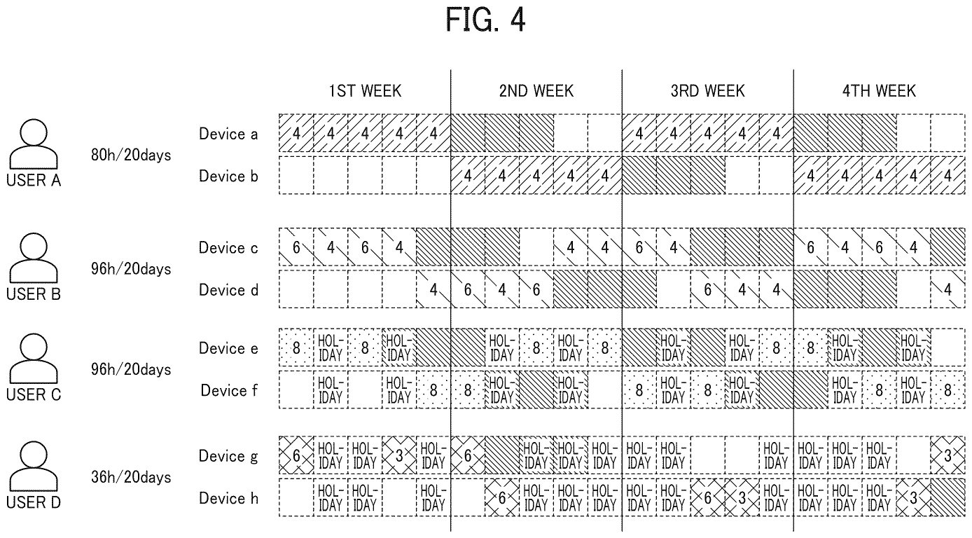

FIG. 1 is a schematic diagram illustrating an overall configuration of an information processing system. FIG. 2 is a diagram illustrating an outline of an operation of the information processing system. FIG. 3 is a diagram illustrating a work time during which a user uses an information technology (IT) device. FIG. 4 is a diagram illustrating a usage time of the IT device by the user in one month. A description is given below of an overall configuration and an outline of an operation of an information processing system 1 with reference to FIGS. 1 to 4.

The information processing system 1 illustrated in FIG. 1 is a system for managing the renting of IT devices from lockers and reducing costs for maintaining and managing the IT devices. As illustrated in FIG. 1, the information processing system 1 includes a locker device management system 10, a device management system 20, a locker management system 30, locker systems 40_1 and 40_2, a first administrator terminal 50, and a second administrator terminal 60.

The locker device management system 10 is a system (management apparatus) for collecting information on IT devices via the device management system 20 and information on the usage state of the IT devices via the locker management system 30, analyzing the information and presenting the IT devices to be rented to users.

The device management system 20 is a system that collects, e.g., information on a discharge rate and error information on an error that has occurred, which may be referred to as device information in the following description, from the IT devices stored in the locker systems 40_1 and 40_2, and transmits the information to the locker device management system 10. In other words, the device information is information indicating the state of the IT device 42, and is an example of “second information” of the present disclosure. The device management system 20 collects device information not only from the IT devices stored in the locker systems 40_1 and 40_2 but also from the IT devices actually rented from the locker systems 40_1 and 40_2. The device information collected by the device management system 20 is not limited to the information on the discharge rate and the error information.

The locker management system 30 is a system that manages locker systems 40_1 and 40_2 that store or rent IT devices, collects, e.g., installation information and usage information (as follows, may be referred to as locker information) of the IT devices managed by the locker systems 40_1 and 40_2, and transmits the information to the locker device management system 10. In other words, the locker information is information indicating the usage state of the IT device 42, and is an example of “first information” of the present disclosure. The locker information collected by the locker management system 30 is not limited to the installation information and the usage information of the IT device.

The locker systems 40_1 and 40_2 are storage facilities that include a plurality of boxes called, e.g., compartments to store IT devices in the boxes, and control and manage the renting of the IT devices according to a request of a user. The locker systems 40_1 and 40_2 include, e.g., a central processing unit (CPU) having an arithmetic function for controlling unlocking and locking of each box, a memory, various actuators for unlocking and locking each box, and a touch panel for performing an input operation and displaying. The locker system 40_1 includes a box 41_1a in which an IT device 42_1a is stored, a box 41_1b in which an IT device 42_1b is stored, and a box 41_1c in which an IT device 42_1c is stored. The locker system 40_2 includes a box 41_2a in which an IT device 42_2a is stored, a box 41_2b in which an IT device 42_2b is stored, and a box 41_2c in which an IT device 42_2c is stored. The locker systems 40_1 and 40_2 transmit, e.g., installation information when an IT device is newly installed or an IT device is removed, and usage information of an IT device rented from each box or returned as locker information to the locker management system 30.

The locker systems 40_1 and 40_2 illustrated in FIG. 1 are examples, and the number of locker systems is not limited to two, and when any of these locker systems is indicated or the locker systems are collectively referred to, the locker systems are referred to simply as “locker systems 40.” The number of boxes included in the locker systems 40_1 and 40_2 is not limited to the number illustrated in FIG. 1. The number of IT devices managed by the locker systems 40_1 and 40_2 is not limited to the number illustrated in FIG. 1. The state in which all the IT devices are stored in the boxes of the locker system 40 is illustrated in FIG. 1. However, when the IT devices are rented, the corresponding boxes are empty. The boxes (e.g., boxes 41_1a to 41_1c and 41_2a to 41_2c illustrated in FIG. 1) included in the locker system 40 are referred to simply as “boxes 41” when any box is indicated or when the boxes are collectively referred to. In addition, when any of the IT devices (the IT devices 42_1a to 42_1c and 42_2a to 42_2c illustrated in FIG. 1) stored or rented in the boxes 41 of the locker system 40 is indicated or collectively referred to, the IT devices are referred to simply as “IT devices 42.”

The box 41 is a box that stores the IT device 42 therein and is controlled to be locked and unlocked by the locker system 40. The boxes 41 are arranged, e.g., in the vertical and horizontal directions. Inside the box 41, e.g., a Universal Serial Bus (USB) cable or a charging stand is installed. Accordingly, when the IT device 42 is stored in the box 41, charging (and communication) is performed by connecting the IT device 42 to the USB cable or by installing the IT device 42 in the charging stand.

The IT device 42 is an IT apparatus having a wireless or wired communication function, which is stored and managed by the locker system 40. The IT device 42 is an IT device such as a laptop personal computer (PC), a tablet terminal, a smartphone, or a mobile phone. The IT device 42 transmits predetermined device information to the device management system 20 by wireless or wired communication.

The first administrator terminal 50 is an information processing apparatus (external terminal) used by, e.g., an administrator who manages the locker device management system 10. The first administrator terminal 50 sets a priority of a condition for selecting the IT device 42 to be rented in the locker system 40, e.g., according to a user interface (UI) screen provided by the locker device management system 10.

The second administrator terminal 60 is an information processing apparatus for registering the IT device 42 to be newly installed as a management target of the locker system 40.

A description is given below of an outline of an operation of the information processing system 1 with reference to FIG. 2.

As described above, an administrator sets the priority of the condition for selecting the IT device 42 to be rented in the locker system 40 by the first administrator terminal 50 (“1. PRIORITY SETTING”illustrated in FIG. 2).

The IT device 42 stored in the locker system 40 or rented out transmits device information such as a discharge rate and generated error information to the device management system 20 periodically or in response to a request from the device management system 20 or the locker device management system 10. The device management system 20 transmits the device information received from the IT device 42 to the locker device management system 10. Accordingly, the locker device management system 10 collects and accumulates the device information from the IT device 42 (“2. DEVICE INFORMATION COLLECTION”illustrated in FIG. 2).

The locker system 40 transmits locker information such as installation information and usage information of the IT device 42 to the locker management system 30 periodically or in response to a request from the locker management system 30 or the locker device management system 10. The locker management system 30 transmits the locker information received from the locker system 40 to the locker device management system 10. Accordingly, the locker device management system 10 collects and accumulates the locker information from the locker system 40 (“3. LOCKER INFORMATION COLLECTION” illustrated in FIG. 2).

A description is given below of an outline of an operation in a case where the user receives the rental of the IT device 42 from the locker system 40. The user performs user authentication for the locker system 40 and performs an operation for receiving the rental of the IT device 42 from the locker system 40 (“4. RENTAL OPERATION” illustrated in FIG. 2). The locker system 40 transmits a rental request to the locker device management system 10 via the locker management system 30 (“5. RENTAL REQUEST” illustrated in FIG. 2).

The locker device management system 10 that has received the rental request acquires or calculates various indices from the device information and the locker information that are accumulated in advance (“6. ACQUISITION AND CALCULATION OF INDEX” illustrated in FIG. 2). The index is a value used as a criterion for renting the IT device 42 to the user. A detailed description is given below of the index. The locker device management system 10 selects the IT device 42 to be rented to the user according to the condition in which the priority is set on the acquired or calculated index (“7. DEVICE SELECTION” illustrated in FIG. 2). The locker device management system 10 transmits the selection result of the IT device 42 to be rented to the locker system 40 via the locker management system 30 (“8. SELECTION RESULT TRANSMITTING”illustrated in FIG. 2).

The locker system 40 displays the received selection result (a list of IT devices 42 to be rented to the user) on, e.g., an attached touch panel or a monitor (“9. DISPLAYING DEVICE TO BE RENTED” illustrated in FIG. 2). The user performs an operation of selecting any IT device 42 from a list of IT devices 42 to be rented, displayed on, e.g., a touch panel, or a monitor. The locker system 40 unlocks the door of the box 41 storing the IT device 42 selected by the user. As a result, the user opens the door of the box 41 and receives the rental of (takes out) the IT device 42 (“10. RENTAL (TAKING OUT)” illustrated in FIG. 2).

The information processing system 1 controls the management and rental of IT devices 42 in this way and thus allows the selection of IT devices to be rented in consideration of the usage of the IT devices. Further, the cost of consumables is reduced by reducing the frequency of replacement of the battery of the IT device 42, and the maintenance cost can be reduced by extending the maintenance interval of the IT device 42, so that the cost of maintenance and management of the IT device 42 is reduced. Additionally, the information processing system 1 also maximizes the utilization efficiency of the IT device 42 from the viewpoint of the usage state of the IT device 42 of the user illustrated in FIGS. 3 and 4.

FIG. 3 illustrates work time of four users (users A to D) using IT devices 42 for one week. In this case, since the number of IT devices 42 to be simultaneously used is four, it is necessary to install four or more IT devices 42 in preparation for the maximum number of IT devices 42 to be used, but there is room to consider how many IT devices 42 are actually installed. FIG. 4 illustrates a time chart of the usage time of the IT devices 42 (devices a to h) for one month of four users (users A to D). In the time chart, a white frame indicates a date and time when the IT device 42 is not used and is waiting in the box 41, and it may be said that the white frame is a time when the IT device 42 is not effectively used. Accordingly, there is room for optimizing or adjusting the number of IT devices 42 to be installed into the locker system 40, and which IT devices 42 are to be rented out from the viewpoint of maximizing the utilization rate of the IT devices 42 and improving the efficiency.

By adopting the information processing system 1 as described above, the correlation of the date, the day of the week, the time zone, and the location with the number of standby IT devices 42 and the supply and demand of IT devices 42 is taken. Accordingly, the number of installed IT devices 42 is optimized, the number of standby IT devices 42 is reduced, the waiting time of the user when there is no rentable IT device 42 is reduced, and the utilization rate of the IT devices 42 is maximized and smoothed. This maximizes the utilization efficiency of the IT device 42. A detailed configuration and operation of the information processing system 1 is given below.

### Hardware Configuration of, e.g., Locker Device Management System

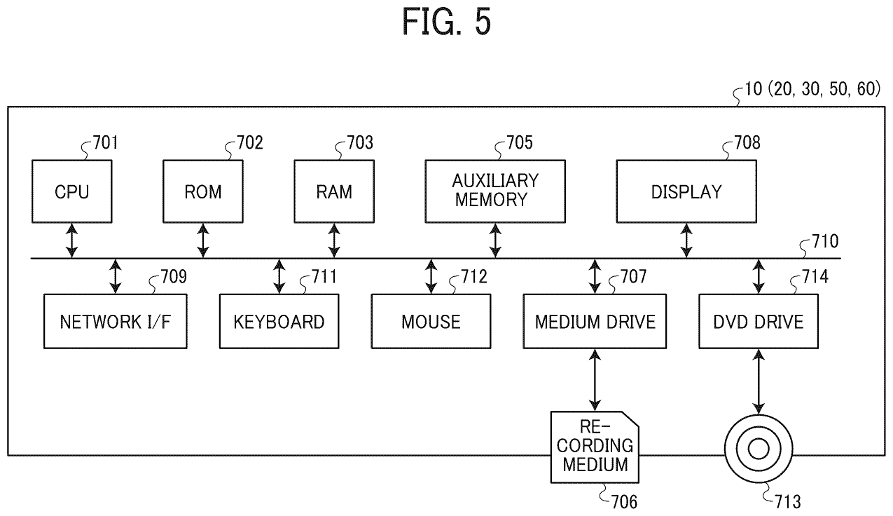

FIG. 5 is a diagram illustrating a hardware configuration of, e.g., the locker device management system. A description is given below of a hardware configuration of, e.g., the locker device management system 10 with reference to FIG. 5. A description is given below of the locker device management system 10 as an example.

As illustrated in FIG. 5, the locker device management system 10 includes a CPU 701, a read-only memory (ROM) 702, a random-access memory (RAM) 703, an auxiliary memory 705, a medium drive 707, a display 708, a network interface (I/F) 709, a keyboard 711, a mouse 712, and a digital versatile disc (DVD) drive 714.

The CPU 701 is a processor that controls the entire operation of the locker device management system 10. The ROM 702 is a non-volatile storage device that stores a program for the locker device management system 10. The RAM 703 is a volatile memory used as a work area for the CPU 701.

The auxiliary memory 705 is a memory such as a hard disk drive (HDD) or a solid-state drive (SSD) that stores various data or programs. The medium drive 707 controls the reading and writing of data from and to a recording medium 706 such as a flash memory under the control of the CPU 701.

The display 708 is a display device that includes, e.g., a liquid crystal display or an organic electro-luminescence (EL) display on which various kinds of information such as a cursor, a menu, a window, characters, and images are displayed.

The network I/F 709 is an interface for communicating with external devices such as the device management system 20, the locker management system 30, and the first administrator terminals 50 via a network. The network I/F 709 is, e.g., a network interface card (NIC) compliant with Ethernet® and can establish communications in compliance with Transmission Control Protocol (TCP)/Internet Protocol (IP).

The keyboard 711 is an input device used for inputting operations such as selecting characters, numerals, or various instructions, and for moving a cursor. The mouse 712 is an input device used for inputting operations such as selecting and executing various instructions, selecting an object to be processed, and moving a cursor.

The DVD drive 714 is a device that reads or writes data to or from a DVD 713 such as a DVD-ROM or a digital versatile disk-recordable (DVD-R), which is an example of a removable storage medium.

The CPU 701, the ROM 702, the RAM 703, the auxiliary memory 705, the medium drive 707, the display 708, the network I/F 709, the keyboard 711, the mouse 712, and the DVD drive 714 are connected to communicate through a bus line 710 such as an address bus or a data bus.

The hardware configuration of the locker device management system 10 illustrated in FIG. 5 is an example, and the locker device management system 10 does not need to include all the components illustrated in FIG. 5, or may include other components. The hardware configuration of each of the device management system 20, the locker management system 30, the first administrator terminal 50, and the second administrator terminal 60 is also similar to the configuration illustrated in FIG. 5. Each of the locker device management system 10, the device management system 20, and the locker management system 30 is not limited to being implemented by a single information processing apparatus as illustrated in FIG. 5, and may be implemented by a plurality of information processing apparatuses or devices.

### Hardware Configuration of IT Device

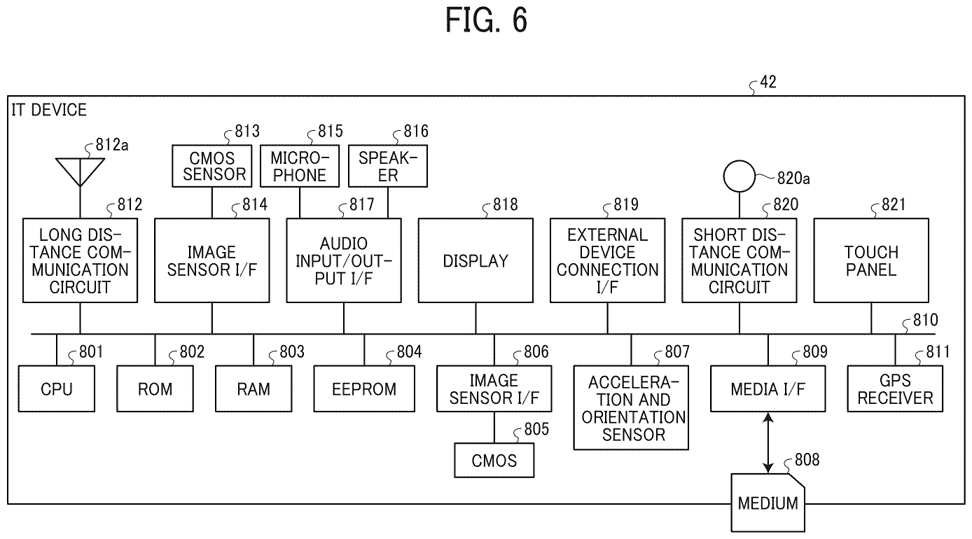

FIG. 6 is a diagram illustrating a hardware configuration of an IT device 42. A description is given below of the hardware configuration of the IT device 42 with reference to FIG. 6. In the example of FIG. 6, a smartphone is used as an example of the IT device 42.

As illustrated in FIG. 6, the IT device 42 includes a CPU 801, a ROM 802, a RAM 803, an electrically erasable programmable read-only memory (EEPROM) 804, a complementary metal oxide semiconductor (CMOS) sensor 805, an image sensor I/F 806, an acceleration and orientation sensor 807, a media I/F 809, and a global positioning system (GPS) receiver 811.

The CPU 801 is a processor that controls entire operation of the IT device 42. The ROM 802 is a non-volatile memory that stores a program, such as an initial program loader (IPL), used for driving the CPU 801. The RAM 803 is a volatile memory used as a work area for the CPU 801.

The EEPROM 804 is an auxiliary memory device that reads or writes various data such as a program for the IT devices 42 under the control of the CPU 801.

The CMOS sensor 805 is a built-in imaging element that captures an object (e.g., a self-image of a user) under the control of the CPU 801 to obtain image data. The CMOS sensor 805 may be an imaging element such as a charge-coupled device (CCD) sensor instead of the CMOS sensor. The image sensor I/F 806 is an interface circuit that controls driving of the CMOS sensor 805.

The acceleration and orientation sensor 807 includes various sensors such as an electromagnetic compass to detect geomagnetism, a gyrocompass, and an acceleration sensor.

The media I/F 809 is an interface circuit that controls reading or writing (storing) of data from or to a medium 808 such as a flash memory.

The GPS receiver 811 is a receiving device that receives a GPS signal from a GPS satellite.

As illustrated in FIG. 6, the IT device 42 includes a long-distance communication circuit 812, an antenna 812a, a CMOS sensor 813, an image sensor I/F 814, a microphone 815, a speaker 816, an audio input/output I/F 817, a display 818, an external device connection I/F 819, a short-distance communication circuit 820, an antenna 820a, and a touch panel 821.

The long-distance communication circuit 812 is a circuit that communicates with another device by wireless communication using the antenna 812a.

The CMOS sensor 813 is a built-in image sensor that captures an object under the control of the CPU 801 to obtain image data. The CMOS sensor 813 may be an image sensor such as a CCD sensor instead of the CMOS sensor. The image sensor I/F 814 is an interface circuit that controls driving of the CMOS sensor 813.

The microphone 815 is a built-in circuit that converts collected sound into an electrical signal. The speaker 816 is a built-in acoustic device that converts an electrical signal into physical vibration to generate sound such as music or voice. The audio input/output I/F 817 is an interface circuit that inputs and outputs audio signals between the microphone 815 and the speaker 816 under the control of the CPU 801.

The display 818 is a display device such as a liquid crystal display or an organic EL display that displays, e.g., an image of an object or various icons.

The external device connection I/F 819 is an interface circuit conforming to, e.g., a USB for connecting various external devices.

The short-distance communication circuit 820 is a communication circuit that performs short-distance communication via the antenna 820a by, e.g., near field communication (NFC) or Bluetooth®.

The touch panel 821 is an input device for operating the IT device 42 by touching a screen of the display 818 by a user.

The IT device 42 also includes a bus 810. The bus 810 is, e.g., an address bus and a data bus for electrically connecting the components such as the CPU 801 illustrated in FIG. 6.

The hardware configuration of the IT device 42 illustrated in FIG. 6 is an example, and the IT device 42 does not need to include all the components illustrated in FIG. 6 or may include other components. For example, the long-distance communication circuit 812 or the short-distance communication circuit 820 may communicate with another device by wired communication, for example, using a cable.

### Functional Configuration and Operation of Information Processing System

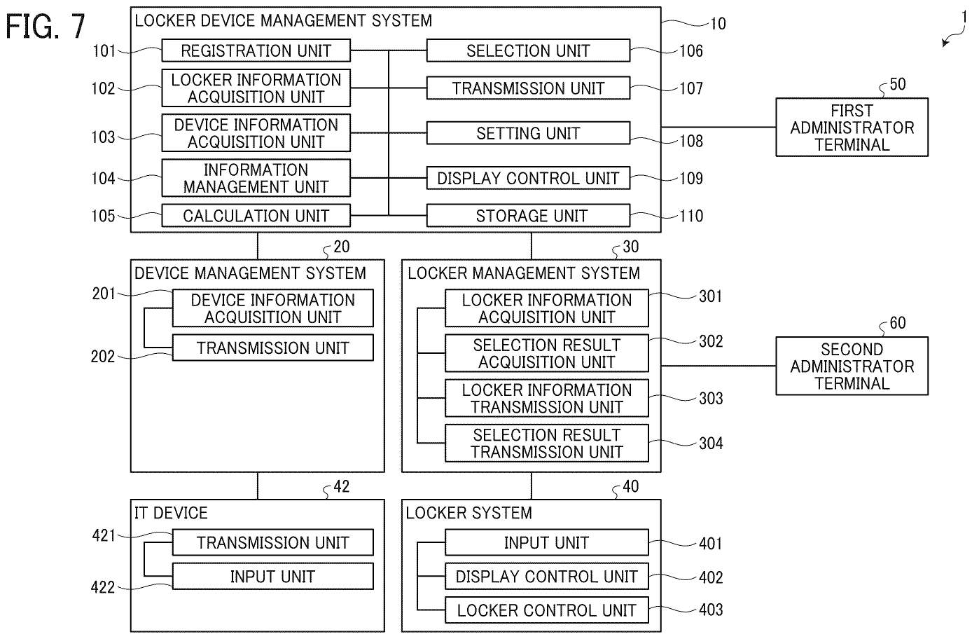

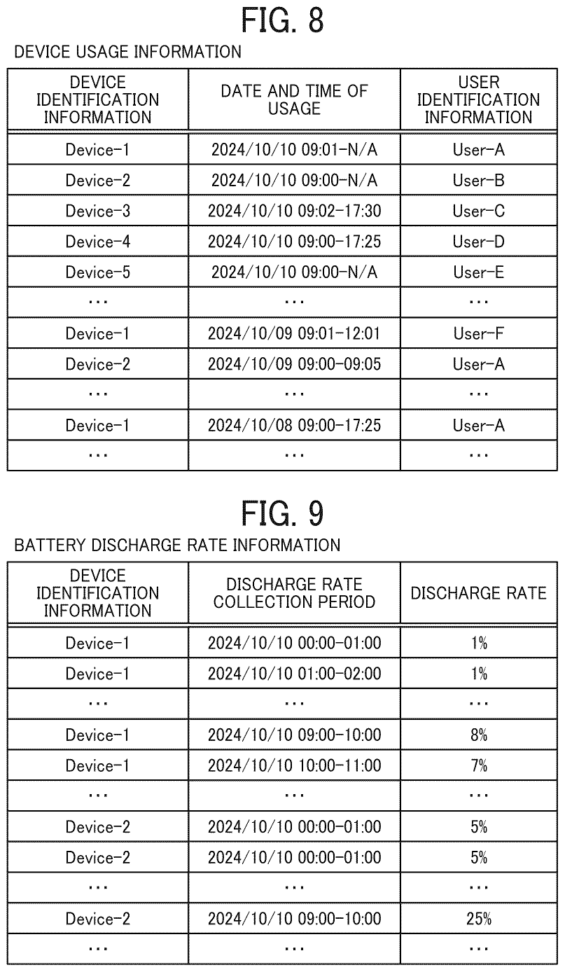

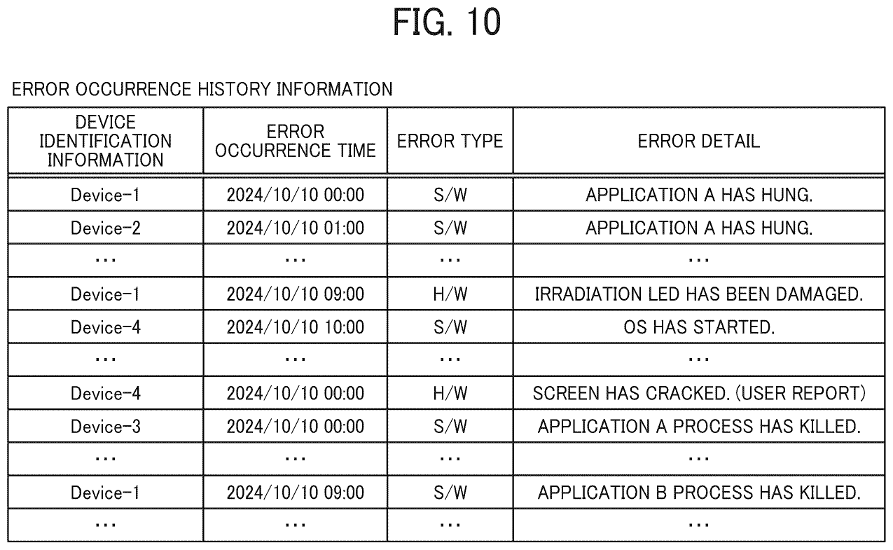

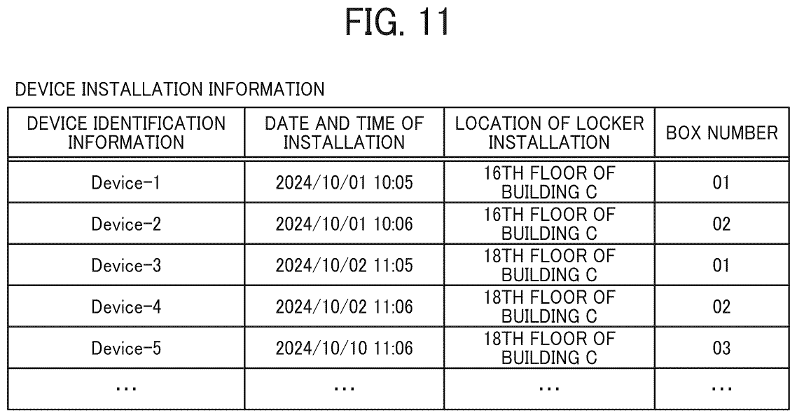

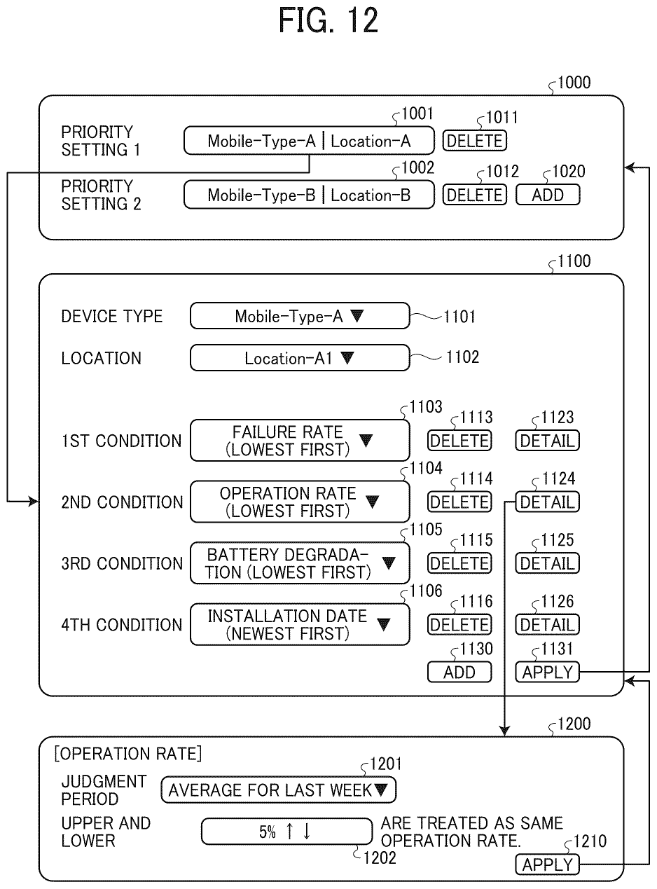

FIG. 7 is a diagram illustrating a functional configuration of the information processing system 1. FIG. 8 is a diagram illustrating device usage information. FIG. 9 is a diagram illustrating battery discharge rate information. FIG. 10 is a diagram illustrating error occurrence history information. FIG. 11 is a diagram illustrating device installation information. FIG. 12 is a diagram illustrating screen transition for priority setting in the information processing system 1. The functional configuration and the operation of the information processing system 1 is described with reference to FIGS. 7 to 12.

As illustrated in FIG. 7, the locker device management system 10 includes a registration unit 101, a locker information acquisition unit 102, a device information acquisition unit 103, an information management unit 104, a calculation unit 105, a selection unit 106, a transmission unit 107, a setting unit 108, a display control unit 109, and a storage unit 110.

The registration unit 101 is a functional unit that registers, in the device installation information loaded in the storage unit 110, installation information (an example of locker information) of the IT device 42 newly installed as a device to be managed by the locker system 40, in accordance with an operation on the second administrator terminal 60. The device installation information is association information for managing information of the IT device 42 newly installed as a device to be managed by the locker system 40, e.g., as illustrated in FIG. 11. As illustrated in FIG. 11, the device installation information manages, e.g., device identification information for identifying the installed IT device 42, an installation date and time indicating the date of installation, a locker installation location indicating in which locker system 40 the IT device 42 is stored, and a box number indicating in which box 41 of the locker system 40 the IT device 42 is stored, in association with each other. The device installation information is implemented as, e.g., information in a table format.

The information included in the device installation information is not limited to the information illustrated in FIG. 11, and may include, e.g., specification information of the IT device 42 to be newly installed.

The locker information acquisition unit 102 is a functional unit that acquires, as locker information, e.g., information indicating the usage state of the IT devices 42 in the locker system 40 transmitted from the locker system 40 and installation information of the IT devices 42 to be newly installed operated by the second administrator terminals 60 as described above from the locker management system 30 via the network I/F 709. The locker information acquisition unit 102 transmits the installation information of the acquired locker information to the registration unit 101.

The device information acquisition unit 103 is a functional unit that acquires, from the device management system 20 via the network I/F 709, the device information such as information on the discharge rates and the error information on the errors that have occurred, which are transmitted from the IT devices 42. The error information transmitted from the IT device 42 may include not only information automatically transmitted from the IT device 42 but also, e.g., error information manually input by the user via the IT device 42.

The information management unit 104 is a functional unit that reflects the locker information acquired by the locker information acquisition unit 102 and the device information acquired by the device information acquisition unit 103 in the storage unit 110 to manage the locker information and the device information.

Specifically, the information management unit 104 reflects information indicating the usage state of the locker information acquired by the locker information acquisition unit 102 in the device usage information loaded in the storage unit 110. The device usage information is association information for managing the usage state of the IT device 42 managed by the locker system 40, e.g., as illustrated in FIG. 8. As illustrated in FIG. 8, the device usage information is managed by associating, e.g., device identification information for identifying the IT device 42, the date and time of use of the IT device 42, and user identification information for identifying the user with each other. The date and time of use includes, e.g., a use start date and time and a use end date and time, and in a case where only the use start date and time is set and the use end date and time is not set (“N/A” illustrated in FIG. 8), it is recognized that the IT device 42 identified by the corresponding device identification information is being rented. The device usage information is implemented as, e.g., information in a table format.

The information included in the device usage information is not limited to the information illustrated in FIG. 8, and may include, e.g., state information indicating the state of the IT device 42 (e.g., waiting, malfunctioning, maintenance, or renting).

The information management unit 104 reflects the information on the discharge rate of the battery in the device information acquired by the device information acquisition unit 103 in battery discharge rate information loaded in the storage unit 110. The battery discharge rate information is association information for managing the discharge rate of the battery included in the IT device 42, e.g., as illustrated in FIG. 9. As illustrated in FIG. 9, the battery discharge rate information is managed by associating device identification information for identifying the IT device 42, a discharge rate collection period indicating a period during which information on the discharge rate of the battery of the IT device 42 is collected, and the discharge rate with each other.

The battery discharge rate information is not limited to being implemented as information in a table format as illustrated in FIG. 9. The battery discharge rate information may be implemented as time series data of the time and the discharge rate for each piece of device identification information.

The information management unit 104 reflects the error information of the device information acquired by the device information acquisition unit 103 in the error occurrence history information loaded in the storage unit 110. The error occurrence history information is, e.g., association information for managing the error information on an error that has occurred in the IT device 42, as illustrated in FIG. 10. As illustrated in FIG. 10, the error occurrence history information manages device identification information for identifying the IT device 42, an error occurrence time, an error type, and error details indicating details of the error in association with each other. The error occurrence history information is, e.g., implemented as information in a table format.

The information included in the error occurrence history information is not limited to the information illustrated in FIG. 10.

The calculation unit 105 is a functional unit that acquires or calculates a predetermined index related to the IT device 42 from, e.g., the device usage information, the battery discharge rate information, the error occurrence history information, and the device installation information stored in the storage unit 110. Examples of the predetermined index include, e.g., the number of detected warnings, the number of failure reports, the charging rate of the battery, the total number of times of use, the total use time (total operation time), an operation rate, a use rate (utilization rate), the waiting time of the user, the history of the number of standby IT devices 42, a battery deterioration degree, a manufacturing date, the installation date, firmware/operating system (OS) information, and a terminal type.

The number of detected warnings indicates the number of warnings that have occurred in the IT device 42 and that are not classified as fatal errors. The number of detected warnings is calculated from, e.g., the device usage information and the error occurrence history information. The reason why the number of detected warnings is calculated by referring to the device usage information is that the number of detected warnings is calculated as the number of warnings generated while the IT device 42 is rented.

The number of failure reports indicates the number of failures of the IT device 42 reported from the user. The number of failure reports may be calculated for, e.g., each category or each degree of importance. The number of failure reports is calculated from, e.g., the device usage information and the error occurrence history information.

The charging rate of the battery indicates an expected charging rate indicating how much charging rate is sufficient for use (utilization) in a predetermined time such as a shift time. The charging rate of the battery is calculated from, e.g., the device usage information and the battery discharge rate information. For example, when the IT device 42 has the charging rate of 50% for one shift time, it is determined that the IT device 42 charged by 50% or more is rentable.

The total number of times of use indicates the total number of times the IT device 42 has been rented from the locker system 40. The total number of times of use is calculated from, e.g., the device usage information.

The total usage time (total operation time) indicates the total time from when the IT device 42 is taken out (rented) from the box 41 of the locker system 40 to when the IT device 42 is returned. The total usage time is calculated from, e.g., the device usage information.

The operation rate is the ratio of the time when the IT device 42 is outside the box 41 and in a usable (utilization) state (i.e., the time the IT device 42 is rented and used normally) to the total time consisting of the time when the device is inside the box 41 and in a usable (utilization) state, the time when the device is outside the box 41 and in a usable (utilization) state, the time when the IT device 42 is outside the box 41 and in an unusable (non-utilization) state, and the time when the IT device 42 is outside the box 41 and in an unusable (non-utilization) state. The operation rate is calculated from, e.g., the device usage information, the battery discharge rate information, and the error occurrence history information.

The usage rate (utilization rate) is the ratio of the time when the IT device 42 is in a usable (utilization) state regardless of whether the IT device is inside or outside the box 41 to the total time consisting of the time when the device is inside the box 41 and in a usable (utilization) state, the time when the device is outside the box 41 and in a usable (utilization) state, the time when the IT device 42 is outside the box 41 and in an unusable (non-utilization) state, and the time when the IT device 42 is outside the box 41 and in an unusable (non-utilization) state. The usage rate (utilization rate) is calculated from, e.g., the device usage information, the battery discharge rate information, and the error occurrence history information.

The waiting time of the user indicates a waiting time from a time point when the user performs the renting operation of the IT device 42 to the locker system 40, due to the absence of the IT device 42 that is rentable in the locker system 40. The waiting time of the user is calculated from, e.g., the device usage information.

The history of the number of IT devices 42 in standby indicates the history of the number of IT devices 42 that are available in the locker system 40 but are stored in the box 41. The history of the number of standby IT devices 42 is calculated from, e.g., the device usage information.

The battery deterioration degree is information indicating, e.g., whether an abnormal discharge state has occurred in the battery of the IT device 42, whether the battery is not charged until the end of the shift work time of the user even when the battery is fully charged, and whether the number of times of charging of the battery exceeds an appropriate range. The battery deterioration degree is calculated from, e.g., the device usage information and the battery discharge rate information.

The manufacturing date indicates the date and time when the IT device 42 was manufactured. The manufacturing date is calculated from, e.g., the device installation information.

The installation date indicates the date and time when the IT device 42 is installed (registered) in the locker system 40. The installation date is calculated from, e.g., the device installation information.

The firmware/OS information indicates information on firmware and an OS installed in the IT device 42. The firmware/OS information is calculated from, e.g., the device installation information.

The terminal type indicates the specification of the IT device 42. The terminal type is calculated from, e.g., the device installation information.

The above-described indices acquired or calculated by the calculation unit 105 are examples, and some of the indices may be acquired or calculated, or indices (e.g., a failure rate) other than the above-described indices may be acquired or calculated.

The selection unit 106 is a functional unit that selects the IT device 42 to be rented to the user according to the condition for the index calculated by the calculation unit 105. As the condition for the index, the priority is set by the setting unit 108 as described later.

The transmission unit 107 is a functional unit that transmits the selection result by the selection unit 106 to the locker management system 30 via the network I/F 709. Further, the selection result is transmitted from the locker management system 30 to the locker system 40.

The setting unit 108 is a functional unit that sets a priority of a condition for selecting an IT device 42 to be rented in the locker system 40 according to an operation on the first administrator terminal 50. The priority indicates a degree of how much priority is given to a condition of selection of the IT device 42 based on each index. A description is given below of a specific procedure for setting the priority with reference to FIG. 12.

Screen information of a priority setting screen 1000, a priority-detail setting screen 1100, and an operation-rate setting screen 1200 illustrated in FIG. 12 is provided from, e.g., the display control unit 109 described later. The administrator operates the first administrator terminal 50 to display a priority setting screen 1000 on the display 708 of the first administrator terminal 50.

The priority setting screen 1000 is a screen for selecting a priority setting for a specific type of IT device 42 (device type) at a specific place (location). The example of the priority setting screen 1000 illustrated in FIG. 12 illustrates a state in which two priority settings of “priority setting 1” and “priority setting 2” are selectable. As illustrated in FIG. 12, the priority setting screen 1000 includes priority setting registration areas 1001 and 1002, delete buttons 1011 and 1012, and an add button 1020.

The priority setting registration area 1001 is an area for selecting the “priority setting 1.” The priority setting registration area 1002 is an area for selecting the “priority setting 2.”

The delete button 1011 is a button for deleting the “priority setting 1.” The delete button 1012 is a button for deleting the “priority setting 2.”

The add button 1020 is a button for adding a new priority setting. Accordingly, by pressing the add button 1020, a new priority setting different from the “priority setting 1” and the “priority setting 2”is added.

It is assumed that the administrator presses (selects) the priority setting registration area 1001 on the priority setting screen 1000 displayed on the first administrator terminal 50. The priority-detail setting screen 1100 is displayed on the display 708 of the first administrator terminal 50.

The priority-detail setting screen 1100 is a screen for setting a specific priority of “priority setting 1.” As illustrated in FIG. 12, the priority-detail setting screen 1100 includes a device type setting area 1101, a location setting area 1102, a first condition setting area 1103, a second condition setting area 1104, a third condition setting area 1105, a fourth condition setting area 1106, delete buttons 1113 to 1116, detail buttons 1123 to 1126, an add button 1130, and an apply button 1131.

The device type setting area 1101 is an area for selecting and setting a device type. For example, the administrator selects a desired device type from a list of device types displayed in a pull down manner by pressing the device type setting area 1101.

The location setting area 1102 is an area for selecting and setting a location. For example, the administrator selects a desired location from a list of locations displayed in a pull down manner by pressing the location setting area 1102.

The first condition setting area 1103 is an area for selecting and setting an index corresponding to a condition having the highest priority (first condition). For example, the administrator selects a desired index from a list of indices displayed in a pull down manner by pressing the first condition setting area 1103. As illustrated in FIG. 12, the failure rate is selected as the index, and in this case, the selection unit 106 selects the IT devices 42 to be rented to the user in ascending order of the failure rate according to a condition (first condition) that the IT devices 42 are selected in ascending order of the failure rate.

The second condition setting area 1104 is an area for selecting and setting an index corresponding to a condition having the second highest priority (second condition). For example, the administrator selects a desired index from a list of indices displayed in a pull down manner by pressing the second condition setting area 1104. As illustrated in FIG. 12, the operation rate is selected as the index, and in this case, the selection unit 106 selects the IT devices 42 to be rented to the user in ascending order of the operation rate according to a condition (second condition) that the IT devices 42 are selected in ascending order of the operation rate.

The third condition setting area 1105 is an area for selecting and setting an index corresponding to a condition having the third highest priority (third condition). For example, the administrator selects a desired index from a list of indices displayed in a pull down manner by pressing the third condition setting area 1105. As illustrated in FIG. 12, the battery deterioration degree is selected as the index, and in this case, the selection unit 106 selects the IT devices 42 to be rented to the user in ascending order of the battery deterioration degree according to a condition (third condition) that the IT devices 42 are selected in ascending order of the battery deterioration degree.

The fourth condition setting area 1106 is an area for selecting and setting an index corresponding to a condition having the fourth highest priority (fourth condition). For example, the administrator selects a desired index from a list of indices displayed in a pull down manner by pressing the fourth condition setting area 1106. As illustrated in FIG. 12, the installation date is selected as the index, and in this case, the selection unit 106 selects the IT devices 42 to be rented to the user in the order of the installation date from the latest IT device 42 according to a condition (fourth condition) that the IT devices 42 are selected in the order of the installation date from the latest IT device 42.

As illustrated in FIG. 12, when the first to fourth conditions to which the priorities are assigned are set, the selection operation by the selection unit 106 is performed, for example, as follows. It is assumed that the final number of IT devices 42 selected by the selection unit 106 as rental targets to the user is ten. In this case, the selection unit 106 selects the IT device 42 to be rented to the user under a condition (first condition) of the highest priority, that is, selection in ascending order of failure rate. As a result, when there are one IT device 42 with the lowest failure rate, one IT device 42 with the second lowest failure rate, and fifteen IT devices 42 with the third lowest failure rate, the selection unit 106 does not narrow down the ten IT devices 42 under the first condition. The selection unit 106 selects the IT devices 42 to be rented to the user under the condition (second condition) of the next highest priority, that is, selecting eight IT devices 42 in ascending order of the operation rate from among the fifteen IT devices 42 having the third lowest failure rate for the first condition. As a result, when there are one IT device 42 with the lowest operation rate, one IT device 42 with the second lowest operation rate, and thirteen IT devices 42 with the third lowest operation rate, the selection unit 106 does not narrow down the eight IT devices 42 under the second condition. In this manner, the selection unit 106 further uses the third condition and the fourth condition in this order for selection until the selection is narrowed down to ten, which is the final selection number. Accordingly, the conditions are used for selecting the IT device 42 in descending order of priority, and there may be a case where all of the plurality of conditions are not used. By selecting the IT device 42 to be rented under the condition in which the priority is set, the utilization rate of the IT device 42 is maximized and smoothed.

The description of the priority-detail setting screen 1100 is continued. The delete buttons 1113 to 1116 are buttons for deleting the first to fourth conditions, respectively. As illustrated in FIG. 12, when the first condition is deleted by pressing the delete button 1113, the priorities of the second to fourth conditions are raised by one, and the first to third conditions are newly set. When the delete buttons 1114 to 1116 are pressed, the priority is similarly adjusted.

The detail buttons 1123 to 1126 are buttons for setting details of the first to fourth conditions, respectively.

The add button 1130 is a button for adding a new condition. The apply button 1131 is a button for fixing the priority setting set on the priority-detail setting screen 1100. When the apply button 1131 is pressed, the setting unit 108 stores the setting content of the priority on the priority-detail setting screen 1100 and the operation-rate setting screen 1200 described later in the storage unit 110 as setting information. Then, the priority setting screen 1000 is displayed on the display 708 of the first administrator terminal 50.

It is assumed that the administrator presses (selects) the detail button 1124 corresponding to the second condition related to the operation rate on the priority-detail setting screen 1100 displayed on the first administrator terminal 50. An operation-rate setting screen 1200 is displayed on the display 708 of the first administrator terminal 50.

The operation-rate setting screen 1200 is a screen for making detailed settings on the handling of the operation rate, which is an index. As illustrated in FIG. 12, the operation-rate setting screen 1200 includes a determination period setting area 1201, a same operation rate setting area 1202, and an apply button 1210.

The determination period setting area 1201 is an area for selecting and setting a period for handling the operation rate. As illustrated in FIG. 12, “average for last week” is selected and set. The same operation rate setting area 1202 is an area for setting a range to be treated as the same operation rate. As illustrated in FIG. 12, it is set that the operation rate is treated as the same operation rate in a range of 5% above and below.

In other words, when the selection unit 106 selects the IT device 42 according to the second condition related to the operation rate, the average value of the latest one week is used as the operation rate, and when each operation rate falls within a range of 5% above and below, these operation rates are treated as the same. As detailed settings for handling the operation rate, the contents illustrated in the operation-rate setting screen 1200 illustrated in FIG. 12 are merely examples, and the setting may be made in other modes. Further, other indices corresponding to the respective conditions set on the priority-detail setting screen 1100 may be set in detail based on the contents according to the operation-rate setting screen 1200. Examples of detailed settings for the charging rate as an index include the setting of selecting an IT device 42 to be rented from the IT devices 42 of a predetermined charging rate (e.g., 80%) or more. Examples of detailed settings for the number of failure reports as an index include the setting of selecting an IT device 42 to be rented from the IT devices 42 of a predetermined number of failure reports (e.g., 1) or less.

The apply button 1210 is a button for fixing the detailed settings of the operation rate set on the operation-rate setting screen 1200.

The priority is specifically set by the settings on the priority setting screen 1000, the priority-detail setting screen 1100, and the operation-rate setting screen 1200 as described above.

The description of the functional blocks illustrated in FIG. 7 is continued. The display control unit 109 is a functional unit that controls a display operation of the display 708 of the first administrator terminal 50 by providing various types of screen information (e.g., the priority setting screen 1000, the priority-detail setting screen 1100, and the operation-rate setting screen 1200) in accordance with an operation in the first administrator terminal 50.

The storage unit 110 is a functional unit that stores, e.g., various types of information illustrated in FIGS. 8 to 11, various types of screen information, and setting information set by the setting unit 108. The storage unit 110 is implemented by at least one of the RAM 703 and the auxiliary memory 705 illustrated in FIG. 5.

The device usage information, the battery discharge rate information, the error occurrence history information, and the device installation information are stored in the storage unit 110 of the locker device management system 10, but the present disclosure is not limited thereto. For example, at least one of the device usage information and the device installation information may be stored and managed by the locker management system 30, and the locker device management system 10 may refer to the locker management system 30. At least one of the battery discharge rate information and the error occurrence history information may be stored and managed by the device management system 20, and the locker device management system 10 may refer to the device management system 20.

The registration unit 101, the locker information acquisition unit 102, the device information acquisition unit 103, the information management unit 104, the calculation unit 105, the selection unit 106, the transmission unit 107, the setting unit 108, and the display control unit 109 are implemented by, e.g., the CPU 701 illustrated in FIG. 5 executing a program. The registration unit 101, the locker information acquisition unit 102, the device information acquisition unit 103, the information management unit 104, the calculation unit 105, the selection unit 106, the transmission unit 107, the setting unit 108, and the display control unit 109 may be implemented by hardware such as an integrated circuit, or may be implemented by a combination of software and hardware.

The functional units of the locker device management system 10 illustrated in FIG. 7 are conceptual representations of functions, and the configuration is not limited to this. For example, a plurality of functional units illustrated as independent functional units in the locker device management system 10 illustrated in FIG. 7 may be implemented as one functional unit. On the other hand, the function of one functional unit in the locker device management system 10 illustrated in FIG. 7 may be divided into a plurality of functions, and the functional unit may be implemented as a plurality of functional units. The functional units of the locker device management system 10 are not necessarily implemented as distinct software modules as the blocks illustrated in FIG. 7, and the individual functions of the functional units may be implemented as a whole by executing a program in the locker device management system 10.

As illustrated in FIG. 7, the device management system 20 includes a device information acquisition unit 201 and a transmission unit 202.

The device information acquisition unit 201 is a functional unit that acquires, via the network I/F 709, the device information such as information on the discharge rates and the error information on the errors that have occurred, which are transmitted from the IT devices 42.

The transmission unit 202 is a functional unit that transmits the device information acquired by the device information acquisition unit 201 to the locker device management system 10 via the network I/F 709.

The device information acquisition unit 201 and the transmission unit 202 described above are implemented by, e.g., the CPU 701 illustrated in FIG. 5 executing a program. The device information acquisition unit 201 and the transmission unit 202 may be implemented by hardware such as an integrated circuit, or may be implemented by using software and hardware in combination.

The functional units of the device management system 20 illustrated in FIG. 7 are conceptual representations of functions, and the configuration is not limited to this. For example, a plurality of functional units illustrated as independent functional units in the device management system 20 illustrated in FIG. 7 may be implemented as one functional unit. On the other hand, the function of one functional unit in the device management system 20 illustrated in FIG. 7 may be divided into a plurality of functions and implemented as a plurality of functional units. The functional units of the device management system 20 do not need to be implemented as distinct software modules as the blocks illustrated in FIG. 7, and the individual functions of the functional units may be implemented as a whole by executing a program in the device management system 20.

As illustrated in FIG. 7, the locker management system 30 includes a locker information acquisition unit 301, a selection result acquisition unit 302, a locker information transmission unit 303, and a selection result transmission unit 304.

The locker information acquisition unit 301 is a functional unit that acquires, as locker information, information indicating the usage state of the IT devices 42 in the locker system 40 transmitted from the locker system 40 and installation information of the IT devices 42 to be newly installed operated by the second administrator terminals 60 as described above via the network I/F 709.

The selection result acquisition unit 302 is a functional unit that acquires the selection result of the IT devices 42 to be rented, which is transmitted from the locker device management system 10, via the network I/F 709.

The locker information transmission unit 303 is a functional unit that transmits the locker information acquired by the locker information acquisition unit 301 to the locker device management system 10 via the network I/F 709.

The selection result transmission unit 304 is a functional unit that transmits the selection result acquired by the selection result acquisition unit 302 to the locker system 40 via the network I/F 709.

The locker information acquisition unit 301, the selection result acquisition unit 302, the locker information transmission unit 303, and the selection result transmission unit 304 are implemented by, e.g., the CPU 701 illustrated in FIG. 5 executing a program. The locker information acquisition unit 301, the selection result acquisition unit 302, the locker information transmission unit 303, and the selection result transmission unit 304 may be implemented by hardware such as an integrated circuit, or may be implemented by a combination of software and hardware.

The functional units of the locker management system 30 illustrated in FIG. 7 are conceptual representations of functions, and the configuration is not limited to this. For example, a plurality of functional units illustrated as independent functional units in the locker management system 30 illustrated in FIG. 7 may be implemented as one functional unit. On the other hand, the function of one functional unit in the locker management system 30 illustrated in FIG. 7 may be divided into a plurality of functions, and the functional unit may be implemented as a plurality of functional units. The functional units of the locker management system 30 do not need to be implemented as distinct software modules as the blocks illustrated in FIG. 7, and the individual functions of the functional units may be implemented as a whole by executing a program in the locker management system 30.

As illustrated in FIG. 7, the locker system 40 includes an input unit 401, a display control unit 402, and a locker control unit 403.

The input unit 401 is a functional unit for a user to perform user authentication and perform an operation input for receiving the rental of the IT device 42. The input unit 401 is implemented by, e.g., an input function of a touch panel of the locker system 40.

The display control unit 402 is a functional unit that displays various operation screens for the user to receive the rental of the IT device 42 on the touch panel of the locker system 40.

The locker control unit 403 is a functional unit that controls the locking and unlocking of the box 41 in accordance with the user's rental operation on the input unit 401. The locker control unit 403 transmits information indicating the usage state of the IT device 42 rented or returned from the box 41 of the locker system 40 (e.g., identification information of the IT device 42, and the date and time of rental or return) to the locker management system 30 as locker information.

As illustrated in FIG. 7, the IT device 42 includes a transmission unit 421 and an input unit 422.

The transmission unit 421 is a functional unit that transmits device information such as a discharge rate and generated error information to the device management system 20 via the long-distance communication circuit 812 periodically or in response to a request from the device management system 20 or the locker device management system 10. The transmission unit 421 may transmit error information manually input by a user through an operation input to the input unit 422 to the device management system 20 as the device information. The transmission unit 421 is implemented by, e.g., the CPU 801 illustrated in FIG. 6 executing a program (such as an application).

The input unit 422 is a functional unit that receives an operation input by use of the rented IT device 42. The input unit 422 is implemented by the touch panel 821 illustrated in FIG. 6.

The transmission unit 421 may be implemented by hardware such as an integrated circuit, or may be implemented by a combination of software and hardware.

The functional units of the IT device 42 illustrated in FIG. 7 are conceptual representations of functions, and the present disclosure is not limited to such a configuration. For example, a plurality of functional units illustrated as independent functional units in the IT device 42 illustrated in FIG. 7 may be implemented as one functional unit. On the other hand, the function of one functional unit in the IT device 42 illustrated in FIG. 7 may be divided into a plurality of functions, and the IT device 42 may be implemented as a plurality of functional units. Further, each functional unit of the IT device 42 does not need to be implemented as a distinct software module as the block illustrated in FIG. 7, and the individual functions of each functional unit may be implemented as a whole by executing a program in the IT device 42.

### Flow of Data Collection Operation of Information Processing System

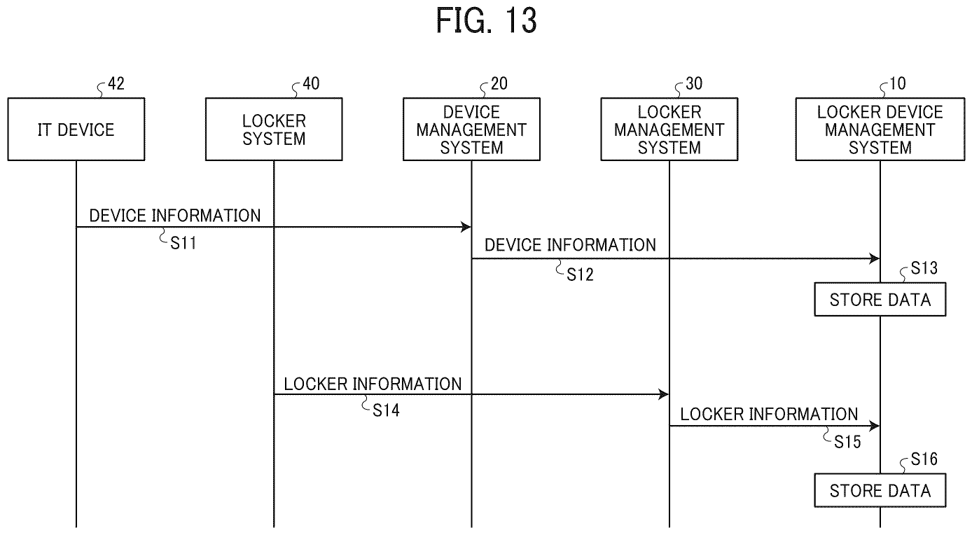

FIG. 13 is a sequence diagram illustrating a flow of a data collection operation of the information processing system 1. A description is given below of a flow of a data collection operation of the information processing system 1 with reference to FIG. 13.

In step S11, the transmission unit 421 of the IT device 42 transmits device information such as a discharge rate and generated error information to the device management system 20 via the long-distance communication circuit 812 periodically or in response to a request from the device management system 20 or the locker device management system 10.

The transmission unit 421 may transmit error information manually input by a user through an operation input to the input unit 422 to the device management system 20 as the device information. The device information acquisition unit 201 of the device management system 20 acquires, via the network I/F 709, the device information such as information on the discharge rates and the error information on the errors that have occurred, which are transmitted from the IT devices 42.

In step S12, the transmission unit 202 of the device management system 20 transmits, via the network I/F 709, the device information acquired by the device information acquisition unit 201 to the locker device management system 10.

The device information acquisition unit 103 of the locker device management system 10 acquires, via the network I/F 709, the device information such as information on the discharge rates and the error information on the errors that have occurred, which are transmitted from the device management system 20.

In step S13, the information management unit 104 of the locker device management system 10 reflects the information on the discharge rate of the battery in the device information acquired by the device information acquisition unit 103 on the battery discharge rate information loaded in the storage unit 110 and accumulates the battery discharge rate information.

The information management unit 104 reflects the error information of the device information acquired by the device information acquisition unit 103 on the error occurrence history information loaded in the storage unit 110 and accumulates the error occurrence history information.

In step S14, the locker control unit 403 of the locker system 40 transmits information indicating the usage state of the IT device 42 rented or returned from the box 41 of the locker system 40 (e.g., identification information of the IT device 42 and the date and time of rental or return) to the locker management system 30 as locker information.

Then, the locker information acquisition unit 301 of the locker management system 30 acquires, as locker information, information indicating the usage state of the IT devices 42 in the locker system 40 transmitted from the locker system 40 via the network I/F 709.

In step S15, the locker information transmission unit 303 of the locker management system 30 transmits the locker information acquired by the locker information acquisition unit 301 to the locker device management system 10 via the network I/F 709.

The locker information acquisition unit 102 of the locker device management system 10 acquires the locker information transmitted from the locker management system 30 via the network I/F 709.

In step S16, the information management unit 104 reflects the information indicating the usage state of the locker information acquired by the locker information acquisition unit 102 on the device usage information loaded in the storage unit 110, and accumulates the device usage information.

In addition to the operation illustrated in FIG. 13, the locker information acquisition unit 102 acquires, as locker information, installation information of the IT devices 42 to be newly installed, which are operated by the second administrator terminals 60 as described above, from the locker management system 30 via the network I/F 709.

The registration unit 101 of the locker device management system 10 registers the locker information (here, the installation information) acquired by the locker information acquisition unit 102 in the device installation information loaded in the storage unit 110.

### Flow of Device Renting Operation of Information Processing System

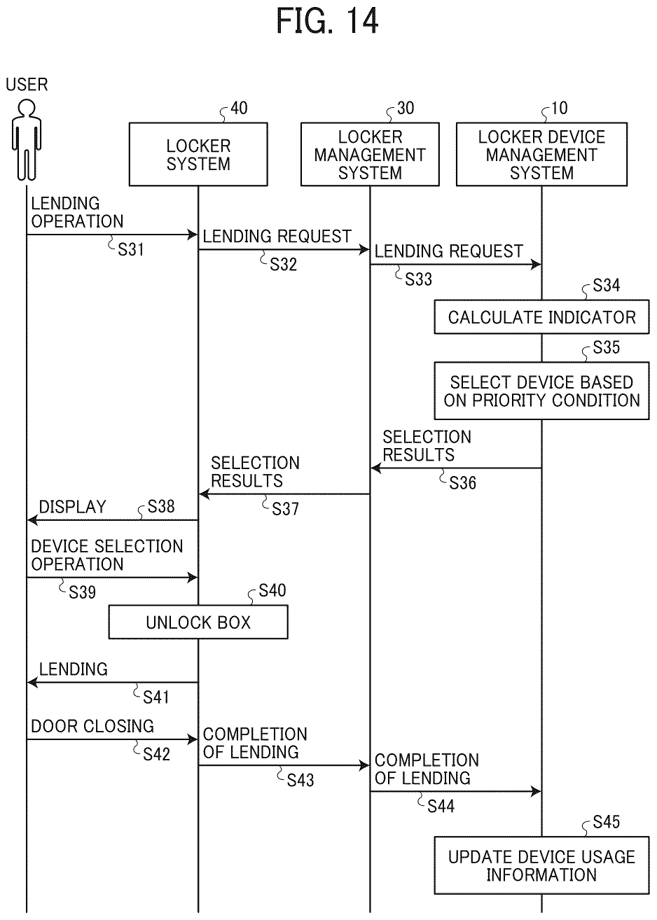

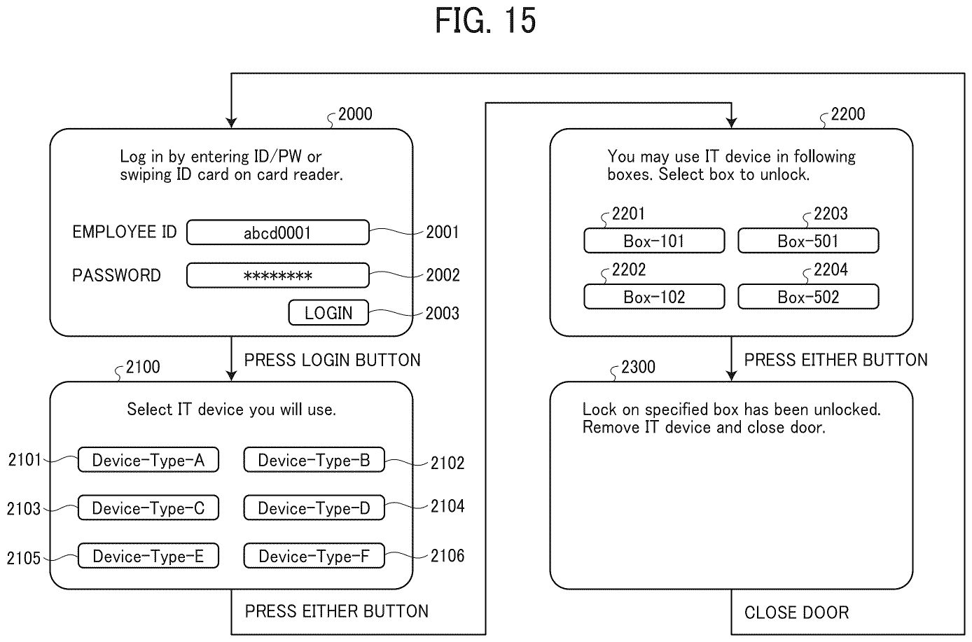

FIG. 14 is a sequence diagram illustrating a flow of a device renting operation of the information processing system 1. FIG. 15 is a diagram illustrating screen transition in the locker system 40 in the device renting operation of the information processing system 1. A description is given below of the flow of the device renting operation of the information processing system 1 with reference to FIGS. 14 and 15.

In step S31, the user performs a rental operation on the input unit 401 of the locker system 40.

Specifically, first, a login operation is performed on a login screen 2000 displayed on the touch panel of the locker system 40.

The login screen 2000 is a screen for the user to input an ID (employee ID) and a password and receive login authentication. As illustrated in FIG. 15, the login screen 2000 includes an ID input area 2001, a password input area 2002, and a login button 2003.

The ID input area 2001 is an area for inputting an ID. The password input area 2002 is an area for inputting a password. The login button 2003 is a button for performing login authentication using an input ID and password.

When the user inputs an ID and a password on the login screen 2000 and presses the login button 2003, the locker control unit 403 performs an authentication process using the ID and the password. The ID and the password may be input by reading an ID card with, e.g., a card reader of the locker system 40. When the authentication is confirmed as the result of the authentication process by the locker control unit 403, the display control unit 402 displays a device type selection screen 2100 as illustrated in FIG. 15 on the touch panel.

The device type selection screen 2100 is a screen for selecting a device type of the IT device 42 desired by the user. As illustrated in FIG. 15, the device type selection screen 2100 includes device type buttons 2101 to 2106.

Device type buttons 2101 to 2106 are buttons for selecting “Device-Type-A” to “Device-Type-F”, respectively, as device types. Although the example of the device type selection screen 2100 illustrated in FIG. 15 includes buttons for selecting six types of device types, the number of types of device types that may be selected is not limited to six.

The user presses a button corresponding to a desired device type among the device type buttons 2101 to 2106 on the device type selection screen 2100 displayed on the touch panel.

In step S32, the locker control unit 403 of the locker system 40 transmits a rental request including the device type selected by the user and information on the location of the locker system 40 to the locker management system 30.

The network I/F 709 of the locker management system 30 receives the rental request.

In step S33, the network I/F 709 of the locker management system 30 transmits the received rental request to the locker device management system 10.

The network I/F 709 of the locker device management system 10 receives the rental request.

In step S34, when the rental request is received by the network I/F 709 of the locker device management system 10, the calculation unit 105 of the locker device management system 10 acquires or calculates predetermined indices related to the IT devices 42 from, e.g., the device usage information, the battery discharge rate information, the error occurrence history information, and the device installation information stored in the storage unit 110.

Specifically, the calculation unit 105 refers to the setting information related to the priority stored in advance in the storage unit 110 by the setting operation by the setting unit 108, and reads the setting information corresponding to the device type and the location included in the rental request. The calculation unit 105 acquires or calculates the index corresponding to each condition in which the priority included in the read setting information is set, from, e.g., the device usage information, the battery discharge rate information, the error occurrence history information, and the device installation information.

In step S35, the selection unit 106 of the locker device management system 10 selects the IT device 42 to be rented from the IT devices 42 that are waiting in the locker system 40 and that correspond to the device type and the location included in the rental request, according to the condition (the condition in which the priority is set) for the index calculated by the calculation unit 105.

Whether the IT device 42 is on standby in the locker system 40 is grasped by, e.g., the state of the IT device 42 in the device usage information. The selection operation by the selection unit 106 in this case is as described above.

In step S36, the transmission unit 107 of the locker device management system 10 transmits the selection result of the IT devices 42 to be rented by the selection unit 106 to the locker management system 30 via the network I/F 709.

The selection result acquisition unit 302 of the locker management system 30 acquires the selection result of the IT devices 42 to be rented, which is transmitted from the locker device management system 10, via the network I/F 709.

In step S37, the selection result transmission unit 304 of the locker management system 30 transmits the selection result acquired by the selection result acquisition unit 302 to the locker system 40 via the network I/F 709.

The locker control unit 403 of the locker system 40 receives the selection result transmitted from the locker management system 30.

In step S38, the display control unit 402 of the locker system 40 displays the selection result received by the locker control unit 403 on the touch panel.

Specifically, the display control unit 402 displays the selection result on a box selection screen 2200 as illustrated in FIG. 15 displayed on the touch panel.

The box selection screen 2200 is a screen for displaying a selection result of the IT devices 42 to be rented in the locker device management system 10 and admitting the user to select a desired IT device 42 from the IT devices 42. In the box selection screen 2200 illustrated in FIG. 15, the selection result is displayed as an arrangement of buttons for selecting boxes in which the IT devices 42 selected by the locker device management system 10 are stored, and a state in which four IT devices 42 are selected is illustrated as the selection result. As illustrated in FIG. 15, the box selection screen 2200 includes box selection buttons 2201 to 2204.

The box selection buttons 2201, 2202, 2203, and 2204 are buttons on which “BOX-101,” “BOX-102,” “BOX-501,” and “BOX-502,” respectively, are displayed as the box names of the boxes 41 in which the IT devices 42 selected as rental targets by the locker device management system 10 are stored.

In step S39, the user performs a selection operation on a desired IT device 42 from the box selection screen 2200 displayed on the touch panel of the locker system 40.

Specifically, the user presses a button corresponding to the box 41 in which the desired IT device 42 is stored, from among the box selection buttons 2201 to 2204 of the box selection screen 2200.

In step S40, the locker control unit 403 unlocks the door of the box 41 corresponding to the button selected by the user.

The display control unit 402 displays, on the touch panel, an unlock notification screen 2300 illustrated in FIG. 15 for notifying that the door of the box 41 selected by the user has been unlocked and prompting the user to take out the IT device 42.

In step S41, the user takes out the IT device 42 from the unlocked box 41.

As a result, the IT device 42 is rent to the user.

In step S42, after taking out the IT device 42, the user closes the door of the box 41.

The locker control unit 403 locks the door of the box 41.

In step S43, the locker control unit 403 transmits, to the locker management system 30, rental completion including the date and time when the IT device 42 is rented to the user, the device identification information of the IT device 42, and the user identification information of the user.

The selection result transmission unit 304 of the locker management system 30 receives the rental completion via the network I/F 709.

In step S44, the selection result transmission unit 304 transmits the received rental completion to the locker device management system 10 via the network I/F 709.

The locker information acquisition unit 102 of the locker device management system 10 acquires the rental completion via the network I/F 709.

In step S45, the information management unit 104 of the locker device management system 10 reflects the rental completion acquired by the locker information acquisition unit 102 in the device usage information.

Specifically, the information management unit 104 adds the device identification information, the use date and time (use start date and time), and the user identification information included in the rental completion acquired by the locker information acquisition unit 102 as a new record in the device usage information.

As described above, the information processing system 1 includes the locker system 40 to store a plurality of the IT devices 42 and the locker device management system 10 that manages the renting of the plurality of IT devices 42. In the locker device management system 10, the storage unit 110 stores the locker information indicating a usage state of each of the plurality of IT devices 42 based on information transmitted from the locker system 40. The selection unit 106 selects a rentable IT device 42 from among a plurality of IT devices 42 stored in the locker system 40 based on the locker information stored in the storage unit 110. The transmission unit 107 transmits a selection result selected by the selection unit 106 to the locker system 40. Accordingly, the cost of maintaining and managing the IT devices 42 is reduced.

In the information processing system 1, the storage unit 110 stores the device information indicating the state of the IT device 42 transmitted from the IT device 42. The selection unit 106 selects a rentable IT device 42 from among the plurality of IT devices 42 stored in the locker system 40 based on the locker information and the device information. The utilization efficiency of the IT device 42 is maximized.

In the information processing system 1, the calculation unit 105 calculates a plurality of indices using the locker information and the device information. The selection unit 106 selects a rentable IT device 42 from among a plurality of IT devices 42 stored in the locker system 40 according to priorities set in advance for respective conditions related to the plurality of indices calculated by the calculation unit 105. The utilization rate of the IT device 42 is maximized and smoothed, thereby maximizing the utilization efficiency of the IT device 42.

When at least one of the functions of the locker device management system 10, the device management system 20, the locker management system 30, and the IT device 42 is implemented by executing a program, the program is provided by being incorporated in, e.g., a ROM in advance. The programs executed by the locker device management system 10, the device management system 20, the locker management system 30, and the IT device 42 may be recorded and provided in a computer-readable recording medium such as a compact disc-read-only memory (CD-ROM), a flexible disk (FD), a compact disc-recordable (CD-R), or a digital versatile disc (DVD) in an installable or executable file format. The programs executed by the locker device management system 10, the device management system 20, the locker management system 30, and the IT device 42 may be stored in a computer connected to a network such as the Internet and provided by being downloaded via the network. The programs executed by the locker device management system 10, the device management system 20, the locker management system 30, and the IT device 42 may be provided or distributed via a network such as the Internet. The programs executed by the locker device management system 10, the device management system 20, the locker management system 30, and the IT device 42 have a module configuration including at least any of the above-described functional units, and as actual hardware, the CPU reads the program from the above-described storage device and executes the program, so that the above-described functional units are loaded on the main storage device and generated.

Some aspects of the present disclosure are described below.

### Aspect 1

An information processing system includes a storage facility to store a plurality of devices and a management system that manages renting of the plurality of devices.

The management system has a storage unit that stores first information indicating a usage state of each of the plurality of devices based on information transmitted from the storage facility.

The management system has a selection unit that selects a device that is rentable from among the plurality of devices stored in the storage facility, based on the first information stored in the storage unit.

The management system has a transmission unit that transmits a selection result selected by the selection unit to the storage facility.

### Aspect 2

The storage unit stores second information that is transmitted from the device and indicates a state of the device.

The selection unit selects the rentable device from among the plurality of devices stored in the storage facility, based on the first information and the second information.

### Aspect 3

The information processing system according to Aspect 2 further includes a calculation unit that calculates an index serving as a determination criterion for renting the device that is rentable to a user, using the first information and the second information.

The selection unit selects the device that is rentable from among the plurality of devices stored in the storage facility, based on a condition for the index calculated by the calculation unit.

### Aspect 4

In the information processing system according to Aspect 2 or 3, the second information includes at least one of information indicating a discharge rate of the device and error information on an error that has occurred in the device.

### Aspect 5

In the information processing system according to any one of Aspects 1 to 4, the first information includes information regarding installation of a new device.

### Aspect 6

In the information processing system according to Aspect 3, the calculation unit calculates a plurality of indices using the first information and the second information.

The selection unit selects a device that is rentable from among the plurality of devices stored in the storage facility, in accordance with priority of each of conditions related to the plurality of indices calculated by the calculation unit.

### Aspect 7

The information processing system according to Aspect 6 further includes a setting unit that sets the priority in accordance with an operation on an external terminal.

### Aspect 8

In the information processing system according to Aspect 6 or 7, the selection unit selects a device from among devices waiting in the storage facility, based on the first information and the second information.

### Aspect 9

A management apparatus includes a storage unit that stores first information indicating a usage state of each of a plurality of devices based on information transmitted from a storage facility that stores the plurality of devices.

The management apparatus includes a selection unit that selects a device that is rentable from among the plurality of devices stored in the storage facility, based on the first information stored in the storage unit.

The management apparatus includes a transmission unit that transmits a selection result selected by the selection unit to the storage facility.

### Aspect 10

A device management method includes storing first information indicating a usage state of each of a plurality of devices in a storage unit based on information transmitted from a storage facility that stores the plurality of devices.

The device management method includes selecting a device that is rentable from among a plurality of devices stored in the storage facility based on the first information stored in the storage.

The device management method includes transmitting a selection result selected by the selecting to the storage facility.

### Aspect 11

A non-transitory recording medium stores a plurality of instructions which, when executed by one or more processors, causes the one or more processors to perform a device management method.

The device management method includes storing first information indicating a usage state of each of a plurality of devices in a storage unit based on information transmitted from a storage facility that stores the plurality of devices.

The device management method includes selecting a device that is rentable from among a plurality of devices stored in the storage facility, based on the first information stored in the storage.

The device management method includes transmitting a selection result selected by the selecting to the storage facility.

In the related art, a usage state of the device is not considered, which may lead to issues such as usage being concentrated on specific devices, potentially causing degradation or failure of those specific devices.

The present disclosure has been proposed in view of the above and aims to provide an information processing system, a management apparatus, a device management method, and a program that select devices that is rentable by considering the usage status of the devices.

According to the present disclosure, to select a device that is rentable is performed in consideration of the usage state of the device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing system comprising:
a memory that stores first information indicating a usage state of each of a plurality of devices in a storage facility based on information transmitted from the storage facility; and
circuitry configured to:
select a device that is rentable from among the plurality of devices stored in the storage facility based on the first information stored in the memory, and
transmit a selection result to the storage facility.

2. The information processing system according to claim 1,
wherein the circuitry is further configured to:
store, in the memory, second information indicating a device state of each of the plurality of devices, the second information being transmitted from each of the plurality of devices stored in the storage facility, and
select the device that is rentable from among the plurality of devices stored in the storage facility based on the first information and the second information.

3. The information processing system according to claim 2,
wherein the circuitry is further configured to:
calculate an index serving as a determination criterion for renting the device to a user based on the first information and the second information, and
select the device that is rentable from among the plurality of devices stored in the storage facility based on the calculated index.

4. The information processing system according to claim 2,
wherein the second information includes at least one of information indicating a discharge rate of the device or information of an error that has occurred in the device.

5. The information processing system according to claim 1,
wherein the first information includes information regarding installation of a new device.

6. The information processing system according to claim 3,
wherein the circuitry is further configured to:
calculate a plurality of the indices including the index based on the first information and the second information, and
select the device that is rentable from among the plurality of devices stored in the storage facility in accordance with a priority set to each of the plurality of indices in selecting the device.

7. The information processing system according to claim 6,
wherein the circuitry is further configured to set the priority in accordance with an operation on an external terminal apparatus.

8. The information processing system according to claim 6,
wherein the circuitry is further configured to select the device from among one or more devices waiting in the storage facility based on the first information and the second information.

9. A management apparatus including circuitry configured to:
store, in a memory, first information indicating a usage state of each of a plurality of devices in a storage facility based on information transmitted from the storage facility which stores the plurality of devices;
select a device that is rentable from among the plurality of devices stored in the storage facility based on the first information stored in the memory; and
transmit a selection result to the storage facility.

10. A device management method, comprising:
storing, in a memory, first information indicating a usage state of each of a plurality of devices in a storage facility based on information transmitted from the storage facility which stores the plurality of devices;
selecting a device that is rentable from among the plurality of devices stored in the storage facility based on the first information stored in the memory; and
transmitting a selection result to the storage facility.
